(19) United States
(12) Patent Application Publication
(10) Pub. No.: US 2026/0366305 A1
(43) Pub. Date: Nov. 19, 2026

(54) A SYSTEM COMPRISING A SENSORIZED TILE AND A METHOD FOR USING A SENSORIZED TILE

(71) Applicant: GRUPPO ROMANI S.P.A., CASALGRANDE (REGGIO EMILIA) (IT)

(72) Inventors: ALESSANDRO BERSELLI, MODENA (IT); MARCO BONVINO, MIRABELLO MONFERRATO (AL) (IT)

(21) Appl. No.: 19/126,028

(22) PCT Filed: Oct. 31, 2023
(86) PCT No.: PCT/IB2023/060945

§ 371 Date: Apr. 30, 2025

(30) Foreign Application Priority Data
Nov. 4, 2022 (IT) 102022000022716
Nov. 4, 2022 (IT) 102022000022749

(51) Int. Cl. E04F 15/08; G01L 5/00; G05B 15/02; H02J 50/10

(52) U.S. Cl. CPC E04F 15/08; G01L 5/0028; G05B 15/02; H02J 50/10; G05B 2219/2642

(57) ABSTRACT

A system includes a sensorized tile, wherein the sensorized tile includes a ceramic body, including a top surface and an underside surface, opposite the top surface; a control unit, positioned on the underside surface and programmed to generate a communication signal; a communication unit, connected to the control unit to receive the communication signal, and a sensing unit configured to capture at least one sensor signal, representing a value of a physical parameter detected in a boundary zone of the tile, wherein the control unit is connected to the sensing unit to receive the at least one sensor signal and is configured to generate the communication signal responsive to the sensor signal.

### TECHNICAL FIELD

This invention relates to a sensorized tile and a method for using a sensorized tile.

Traditionally, ceramic tiles are used for covering floors, walls and other surfaces, in bathrooms and kitchens, for example. The purpose of these tiles is to finish and decorate the surfaces they are applied on.

### BACKGROUND ART

Patent document IT102017000042869 describes a tile comprising an induction charging system; that tile, however, is not suitable for performing any functions other than charging.

Patent document EP2425068B1 describes a flooring system comprising an accumulation device and a related method of production and use. Patent document JPS5820411A describes a method for producing tiles. Patent document EP3910430A1 relates to a method for assigning a position of a lining element with respect to a spatial reference system. None of these documents satisfactorily meets market needs, however.

### DISCLOSURE OF THE INVENTION

The aim of this disclosure is to provide a tile and method to overcome the above mentioned drawbacks of the prior art. Another aim of this disclosure is to provide a tile production method that overcomes the drawbacks of the prior art.

In particular, this disclosure has for an aim to provide a tile which is capable of processing signals and communicating with the outside. Another aim of this disclosure is to provide a tile which is capable of monitoring the surrounding environment.

A yet further aim of this disclosure is to provide a system comprising a tile and a method for using a tile, where the tile is a sensorized tile.

These aims are fully achieved by the tile, by the method for communicating with a tile, by the system and the method for using a sensorized tile and by the method for manufacturing a tile, in accordance with this disclosure and as characterized in the appended claims.

The tile comprises a body and preferably the body is a ceramic body. The ceramic body includes a top surface and an underside surface opposite the top surface. For example, the top surface is a visible surface and the underside surface defines a laying surface, configured to be fixed to a supporting surface when the tile is installed. In an example, the tile is a sensorized tile.

The tile comprises a control unit. The control unit may be located outside the ceramic body or, preferably, it may be positioned in the ceramic body or, more preferably, on the underside surface of the ceramic body.

The control unit is programmed to generate a signal. In an example, the signal is a communication signal. The tile comprises a communication unit. The communication unit may be connected to the control unit to receive the communication signal. The communication unit may be located outside the ceramic body or, preferably, it may be positioned in the ceramic body or, more preferably, on the underside surface of the ceramic body. The communication unit may be configured to send signals. In an example, the communication unit is configured to send the communication signal to a remote terminal.

According to an aspect of this disclosure, the tile comprises a sensing unit. The sensing unit is configured to capture at least one sensor signal. The sensor signal preferably represents a value of a physical parameter, for example, detected in a boundary zone of the tile. For this purpose, the sensing unit or the control unit may be programmed to derive the value of the physical parameter from the sensor signal. The control unit may be connected to the sensing unit to receive the at least one sensor signal and, in an example, the control unit derives, from the sensor signal, the value of the corresponding physical parameter.

The sensing unit may be located outside the ceramic body or, preferably, it may be positioned at least partly in the ceramic body or, more preferably, it may be positioned on the underside surface of the ceramic body.

In an embodiment, the sensing unit comprises one or more sensors selected among a temperature sensor. a humidity sensor, an inclination sensor, a pressure sensor, an oscillation sensor and a deformation sensor. The temperature sensor is configured to capture a temperature signal. The temperature signal represents a value of temperature in the boundary zone of the tile, for example, on the top surface or on the underside surface of the tile. The humidity sensor is configured to capture a humidity signal, representing a value of humidity in the boundary zone of the tile, for example, on the top surface or on the underside surface of the tile. The inclination sensor is configured to capture an inclination signal, representing a value of the inclination of the ceramic body (that is, of the top surface or of the underside surface of the ceramic body) relative to a plane perpendicular to the direction of the weight force. The pressure sensor is configured to capture a pressure signal, representing a value of pressure applied to the top surface of the ceramic body. The oscillation sensor is configured to capture an oscillation signal, representing a value of vibration to which the ceramic body is subjected. The deformation sensor is configured to capture a deformation signal, representing a value of deformation of the ceramic body.

The purpose of the sensing unit is to monitor a boundary zone of the tile. In an example, the sensing unit comprises the oscillation sensor, the pressure sensor and the deformation sensor so as to detect a state of a structure in which the tile is installed, such as a ventilated façade, for example. In an example, the sensing unit comprises the pressure sensor to detect a passage of people or things on a floor in which the tile is installed, such as a floating floor, for example. In an example, the sensing unit comprises the oscillation sensor to detect seismic phenomena.

The sensors of the sensing unit may be configured to capture the sensor signals based on a threshold value being exceeded and, alternatively or in addition, based on an event (for example, a pressure applied on the ceramic body or an oscillation event). That way, the sensing unit is able to react to significant external stresses and to temporary external stresses. The sensors of the sensing unit may be low energy consumption sensors. That way, the sensing unit is always ready to capture the sensor signals. For this purpose, the tile may include a power supply system for powering the sensing unit. In an example, the control unit and the communication unit are powered by a battery system. The sensors of the sensing unit may be MEMS sensors, that is to say miniaturized sensors (for example, micro-sized or nano-sized). MEMS sensors have the advantage of allowing accurate detection of physical parameters.

In an example embodiment, the control unit is configured to generate the communication signal based on the at least one sensor signal. Thus, the communication signal may represent the value of the physical parameter detected in the boundary zone of the tile. For this purpose, the sensor signal may comprise at least one between the temperature signal, the humidity signal, the inclination signal, the pressure signal, the oscillation signal and the deformation signal. The communication signal may comprise at least one between the temperature value, the humidity value, the inclination value, the pressure value, the oscillation value and the deformation value. In an example embodiment, the communication unit comprises a transmitting device, configured to transmit the communication signal, for example to a remote terminal. For example, the communication signal is a wireless signal.

In an example, the tile comprises a recess. The recess may define a cavity or indentation in the ceramic body. The recess may be made in the top surface or, preferably, in the underside surface of the ceramic body. The recess has a perimeter edge. The perimeter edge of the recess may be circular, rectangular or any other shape. In other words, the perimeter edge makes a circular, rectangular or any other shape around an axis normal to a surface, that is to say, normal to the top surface or to the underside surface of the ceramic body. Preferably, the perimeter edge of the recess includes rounded corners. The rounded corners have the function of minimizing corner tension, thus making the ceramic body, including the recess, more robust. The control unit may be positioned at least partly in the recess. In other words, the recess may be configured to at least partly house the control unit. The communication system may be positioned at least partly in the recess. The recess may be configured to at least partly house the communication unit. The sensing unit may be positioned at least partly in the recess. For example, the sensing unit may comprise a first sensor positioned in the recess and a second sensor positioned on the top surface of the ceramic body or positioned outside the ceramic body.

In an example, the tile is configured to be installed in flooring. The control unit and/or the communication unit and/or the sensing unit may be located in the flooring at the recess in the tile.

In an example, the tile includes an electronic card. For example, the control unit, the communication system and the sensing unit may be positioned on the electronic card. The card is preferably positioned in the recess. It is noted that the shape and size of the recess (in particular, of the perimeter edge of the recess) may be such as to accommodate the electronic card (that is, the control unit and the communication unit). In an example, the control unit, the communication unit, the sensing unit or the electronic card are inserted in the recess removably.

In an example, the tile includes a power supply system, preferably positioned on the electronic card. In an example, the power supply system includes a plurality of batteries. The batteries of the plurality may be primary batteries or secondary (that is, rechargeable) batteries. Preferably, the batteries of the plurality are reduced thickness lithium batteries, for example, lithium button batteries. The electronic card may include a lid, for example a magnetic lid, configured to cover the battery system. The magnetic lid has the advantage of being easy to open for replacing the batteries of the battery system, especially in the case where the batteries are primary batteries. Preferably, the electronic card and the lid of the battery system are located in the recess, flush with the underside surface of the ceramic body.

In an embodiment, the ceramic body is an axisymmetric body, defining at least one axis of symmetry. Preferably, the perimeter edge of the recess is spaced from the axis of symmetry in a plane parallel to the top surface. Thus, the recess is positioned in the ceramic body at a point far from the centre of the ceramic body, where the bending moment is low.

In an embodiment, the ceramic body comprises a respective perimeter edge, and a distance between the perimeter edge of the recess and the perimeter edge of the ceramic body is greater than 4 cm and is preferably 5 cm. Thus, the recess is positioned in the ceramic body at a point that is far enough from the centre of the ceramic body to protect the control unit, the communication system and, when present, the sensing unit, as much as possible from possible bending of the ceramic body.

In an example, the recess comprises a bottom surface. The ceramic body may comprise a first portion, having a first thickness, included between the top surface and the underside surface. The ceramic body may comprise a second portion, having a second thickness, included between the top surface and the bottom surface of the recess. The first thickness and the second thickness are defined parallel to an axis normal to a surface (for example, normal to the top surface or to the underside surface of the ceramic body). In an example, the second thickness is between 3 mm and 8 mm, preferably 5 mm. In an example, the first thickness is between 8 mm and 20 mm.

In an example embodiment, the control unit, or the communication unit or the sensing unit may be fixed to the recess mechanically (for example, using leaf spring clips) or, more preferably, using a resinous or other gluing material. Preferably, the control unit, the communication system and the sensing unit are located on the electronic card and the electronic card is fixed to the recess by a resin. In an example, the power supply system is located on the electronic card and the electronic card is fixed to the recess by a resin, where the resin is in contact with the control unit, the communication system and the sensing unit and the power supply system is covered by the lid. Preferably, the resin is poured into the recess onto the electronic card (preferably excepting the power supply system) flush with the underside surface of the ceramic body.

In an example, the ceramic body is made from a mixture comprising a toughening agent. In an example, the toughening agent has a concentration of between 0.1% and 4% of the mixture. Preferably, the toughening agent has a concentration of between 0.2% and 0.5%, more preferably between 0.3% and 0.45%, giving the most advantageous results with a concentration of around 0.4%. The function of the toughening agent is to make the ceramic body more resistant to bending, making it more elastic, and at the same time easy to work during the formation of the tile.

This disclosure also provides a system comprising a tile, where the tile is preferably made according to one or more aspects set out in this disclosure. In an example, the system comprises a remote terminal. The remote terminal may be connected to the control unit of the tile. For example, the remote terminal is configured to receive the communication signal and to process the communication signal. The remote terminal may derive information relating to the boundary zone of the tile, based on the communication signal. In another example, the control unit processes the communication signal and derives information relating to the boundary zone of the tile, based on the communication signal.

In an embodiment, the system comprises one or more actuators. The remote terminal may be configured to send drive signals to the one or more actuators, for example based on the communication signal, preferably received from the control unit. In another example, the control unit is configured to send drive signals to the one or more actuators based on the sensor signal, preferably received from the sensing unit.

This disclosure also provides a method for exchanging signals with a tile. The tile preferably comprises a ceramic body, including a top surface and an underside surface opposite the top surface, a control unit, positioned on the underside surface, and a communication unit, connected to the control unit. In an example, the method comprises a step of generating a communication signal via the control unit. The method may comprise a step of sending the communication signal to a remote terminal through the communication unit.

In an example, the tile comprises a sensing unit, connected to the control unit, and the method comprises a step of capturing a sensor signal via the sensing unit. The sensor signal may represent a value of a physical parameter, for example, detected in a boundary zone of the tile. The method may comprise a step of receiving the at least one sensor signal at the control unit. Preferably, the step of generating the communication signal is performed on the basis of the sensor signal received.

In an example, the communication unit comprises a transmitting device and the method comprises a step of transmitting, via the control unit, the communication signal representing the value of the physical parameter detected in the boundary zone of the tile.

In an example, the method comprises a step of sending drive signals to one or more actuators via a remote terminal, based on the communication signal received from the control unit.

In an example, the method comprises a step of sending drive signals to one or more actuators via the control unit, based on the communication signal received from the sensing unit.

This disclosure also provides a method for making a tile, where the tile preferably comprises a ceramic body, including a top surface and an underside surface opposite the top surface. Preferably, the tile comprises a recess. The recess may define a cavity or an indentation in the ceramic body. For example, the recess may be made in the underside surface or in the top surface of the ceramic body. The method may comprise a step of feeding a cavity of a first element with a ceramic mix. The method may comprise a step of compressing the ceramic mixture by moving the first element and a second element towards each other to form the ceramic body of the tile. In an example, during the step of compressing, a recess is formed in the ceramic body, preferably by the first element or by the second element. The first element and the second element each comprise a contact surface. For example, the first element or the second element may comprise a protrusion extending towards an axis normal to the contact surface so as to make a recess in the ceramic body. In particular, the first element comprises a contact surface which, during the step of compressing, is in contact with the underside surface of the tile and the first element may comprise a protrusion extending towards an axis normal to the contact surface so as to make a recess. The recess is made in the underside surface or in the top surface of the ceramic body. In another example, the first element comprises a contact surface which, during the step of compressing, is in contact with the underside surface of the tile and the method comprises a step of removing a portion of the tile so as to make a recess in the underside surface of the ceramic body.

In an example, the method comprises a step of providing a control unit. The method may comprise a step of providing a communication unit, connected to the control unit. The method comprises a step of assembling the control unit to the ceramic body. The method comprises a step of assembling the communication system to the ceramic body. Preferably, the control unit and/or the communication system are positioned at least partly in the recess.

The method may comprise a step of installing the tile in a floor. In an example, the method comprises a step, of installing the control unit and/or the communication unit and/or the sensing unit at the recess of the tile in the floor.

This disclosure also provides a system comprising a sensorized tile. The sensorized tile includes a body, preferably a ceramic body, including a top surface and an underside surface opposite the top surface. The sensorized tile may comprise a control unit, for example positioned on the underside surface and programmed to generate a communication signal. The sensorized tile may comprise a communication unit, connected to the control unit to receive the communication signal. The communication unit may be positioned on the underside surface. The sensorized tile may comprise a sensing unit, configured to capture at least one sensor signal representing a value of a physical parameter detected in a boundary zone of the tile. The sensing unit may be positioned on the underside surface. In an example, the control unit is connected to the sensing unit to receive the at least one sensor signal and is configured to generate the communication signal in response to the sensor signal.

In an example, the sensing unit comprises one or more of the following sensors:
a temperature sensor, configured to capture a temperature signal, representing a value of temperature in the boundary zone of the tile;
a humidity sensor, configured to capture a humidity signal, representing a value of humidity in the boundary zone of the tile;
an inclination sensor, configured to capture an inclination signal, representing a value of the inclination of the ceramic body relative to a plane perpendicular to the direction of the weight force;
a pressure sensor, configured to capture a pressure signal, representing a value of pressure applied to the top surface of the ceramic body;
an oscillation sensor, configured to capture an oscillation signal, representing a value of vibration to which the ceramic body is subjected;
a deformation sensor, configured to capture a deformation signal, representing a value of deformation of the ceramic body.

In an example, the control unit is programmed to derive the values from the corresponding signals processed by the sensing unit.

In an example, the system comprises one or more actuators from those listed below:
an alerting system configured to issue an alert signal;
a sound system (for example, a stereo system), configured to issue a music signal;
a lighting system configured to switch on or switch off;
a camera system configured to switch on or switch off.

One or more actuators may be integrated in the sensorized tile or may be located externally and connected to the sensorized tile. For example, the camera system may be integrated in the outside surface of the body of the sensorized tile.

In an example, the sensing unit comprises the pressure sensor, and the control unit is programmed to derive the pressure value. The control unit may be programmed to compare the pressure value with a predetermined pressure value and to generate a drive signal based on an enabling condition satisfied by the pressure value. In several examples, the enabling condition may be a pressure value greater than the predetermined pressure value, or it may be a preset length of pressure time of the pressure value, or it may be a preset number of pressure times of the pressure value.

In an example, the system comprises the alerting system and the control unit is configured to send the drive signal to the alerting system to instruct it to issue an alert signal. The alert signal may be acoustic, or visual, or luminous, or vibrational.

In an example, the system comprises the sound system and the control unit is configured to send the drive signal to the sound system to instruct it to issue a music signal. The sound system may be a stereo system connectable to the control unit of the tile.

In an example, the system comprises the lighting system and the control unit is configured to send the drive signal to the lighting system to instruct it to switch on or switch off.

In an example, the system comprises the camera system and the control unit is configured to send the drive signal to the camera system to instruct it to switch on or switch off.

In an embodiment, the tile comprises a wireless charging system, configured to transmit electrical energy in wireless mode to an external power supply to charge it. For this purpose, the external power supply may be configured to receive electrical energy in wireless mode.

In an example embodiment, the system comprises a remote terminal. Preferably, the remote terminal is connected to the control unit of the tile, for example to receive the communication signal from the communication unit. The remote terminal (or the control unit) may be programmed to derive information relating to the boundary zone of the tile, based on the communication signal. For example, the information derived by the remote terminal or by the control unit comprises at least one parameter. The parameter may represent a condition of the tile, or an environmental condition, or it may represent a condition of a building (or of a surface) in which the tile is installed. For example, the sensing unit comprises the temperature sensor and the humidity sensor in order to detect a temperature and humidity signal; the information processed may include the values of temperature and humidity and the control unit (or the remote terminal) may be programmed to display the information on a screen. The control unit or the remote terminal may be configured to display the information on a screen. The screen may be included in the remote terminal or it may be included in the tile.

In an example, the communication signal represents a value of pressure over time applied on the ceramic body of the tile. The remote terminal (or the control unit) may be programmed to derive statistical information regarding the values of pressure applied on the ceramic body. For example, the remote terminal (or the control unit) may be programmed to derive a number of people walking on the tile. The remote terminal (or the control unit) may be programmed to derive a length of time a person stood on the tile, for each person or for a preset time interval. The remote terminal (or the control unit) may be programmed to process the number of people who walked on the tile or the length of time they stood on it, thereby providing a user with statistical information.

This disclosure also provides a method for using a tile, where the tile is preferably a sensorized tile.

The method may comprise a step, via the control unit, of generating a communication signal and transmitting the communication signal, for example to the communication unit. The method may comprise a step, via the sensing unit, of capturing at least one sensor signal, representing a value of a physical parameter detected in a boundary zone of the tile, and transmitting the sensor signal, for example to the control unit. The method may include a step, via the control unit, of receiving the at least one sensor signal and generating the communication signal in response to the sensor signal.

In an embodiment, the sensing unit comprises the pressure sensor, and the method comprises a step of deriving a pressure value, for example via the control unit or a remote terminal. The method may comprise a step of comparing the pressure value with a predetermined pressure value via the control unit or via the remote terminal. The method may include a step of generating a drive signal via the control unit or via the remote terminal, for an enabling condition satisfied by the pressure value compared to the predetermined pressure value. For example, the method may include a step of generating a drive signal via the control unit or via the remote terminal, for the pressure value greater than the predetermined pressure value.

In an example, the method comprises a step of transmitting the drive signal, via the control unit, to at least one of the following:
an alerting system to instruct it to issue an alert signal;
a sound system to instruct it to issue a music signal;
a lighting system to instruct it to switch on or switch off;
a camera system to instruct it to switch on or switch off.

In an embodiment, the tile comprises a wireless charging system, and the method comprises a step of transmitting electrical energy in wireless mode to an external power supply to charge it.

In an example, the method comprises a step of sending the communication signal to a remote terminal via the control unit. The communication signal may represent a value of pressure over time applied on the ceramic body of the tile. The method may comprise a step, via the remote terminal, of deriving a number of persons walking on the tile and/or a length of time each person stands on the tile.

### BRIEF DESCRIPTION OF THE DRAWINGS

These and other features will become more apparent from the following description of a preferred embodiment, illustrated by way of non-limiting example in the accompanying drawings, in which:

FIGS. 1 and 2 illustrate a tile 100 according to one or more aspects of this disclosure;

FIG. 3 illustrates a cross section of the tile 100 according to one or more aspects of this disclosure;

FIGS. 4 and 5 illustrate an electronic card 2 according to one or more aspects of this disclosure;

FIGS. 6a and 6b illustrate a system 101 according to one or more aspects of this disclosure;

FIG. 7 illustrates a mould 7 according to one or more aspects of this disclosure.

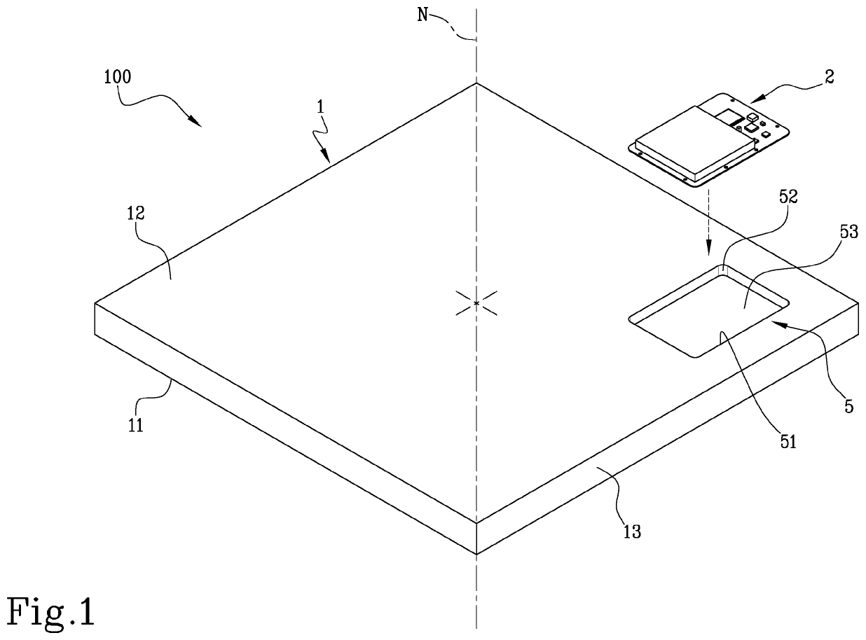

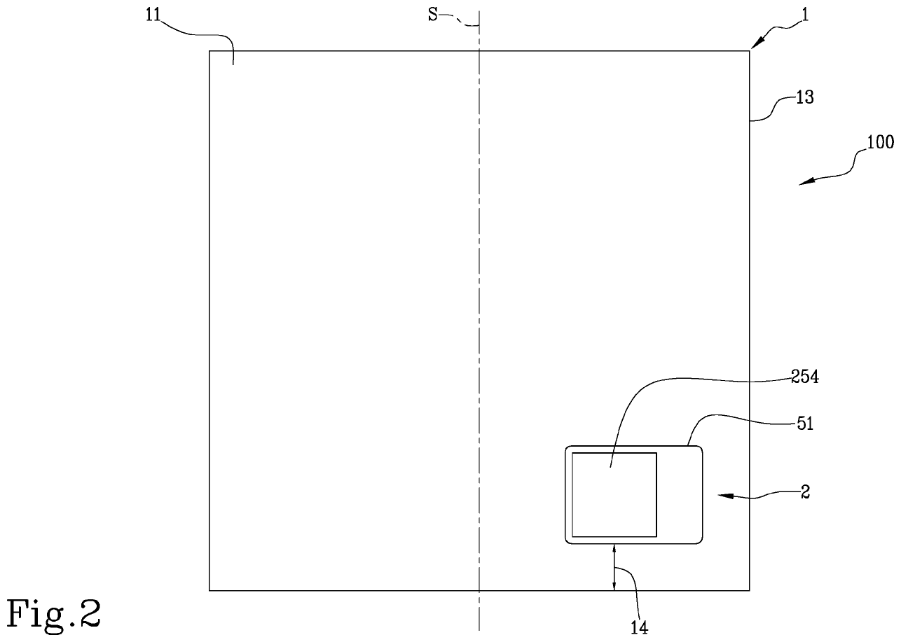

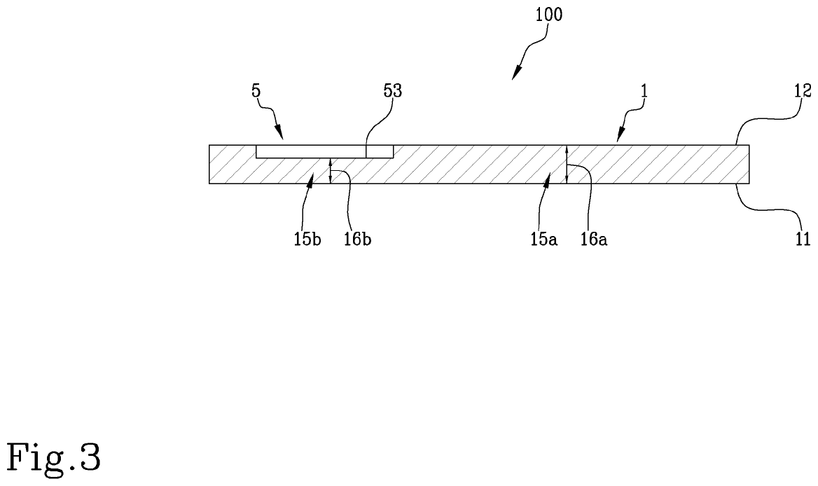

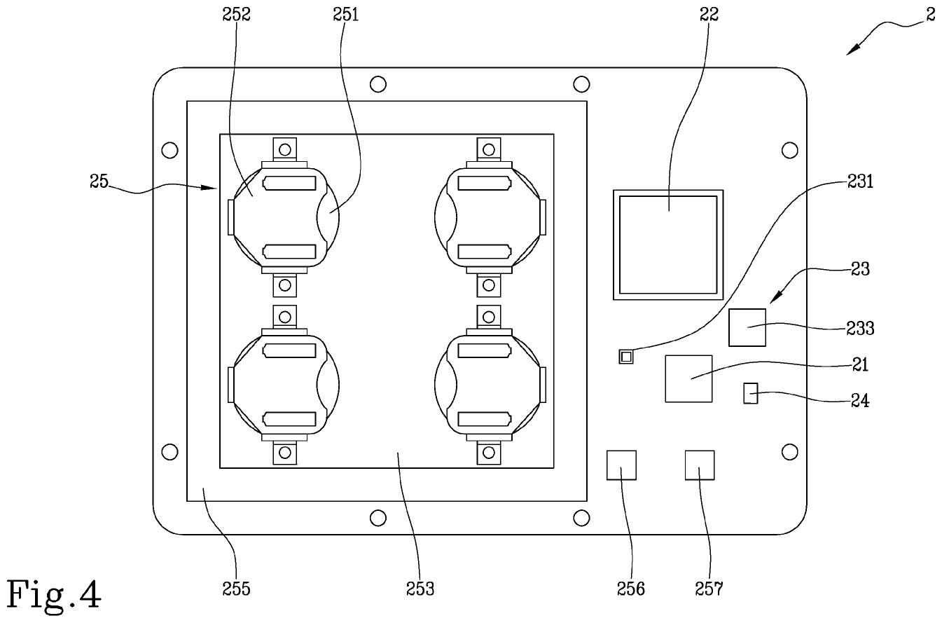

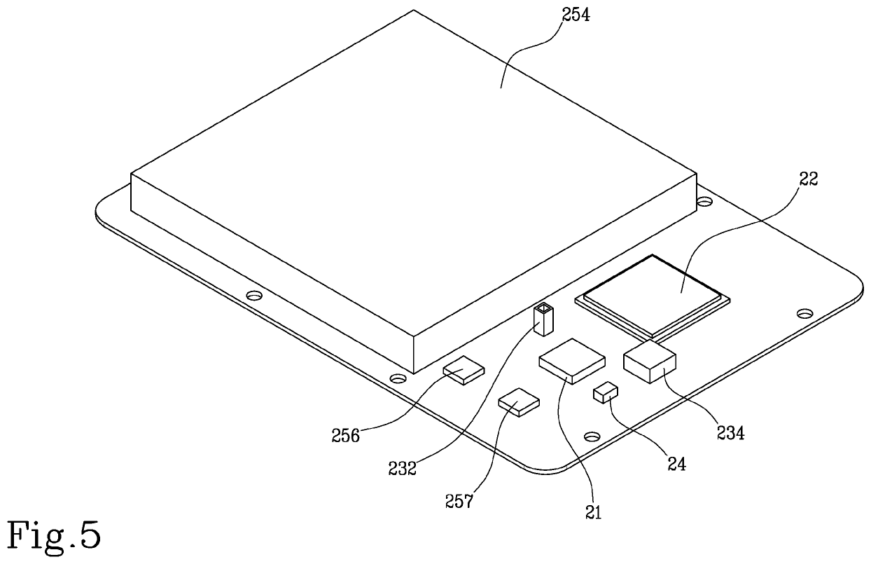

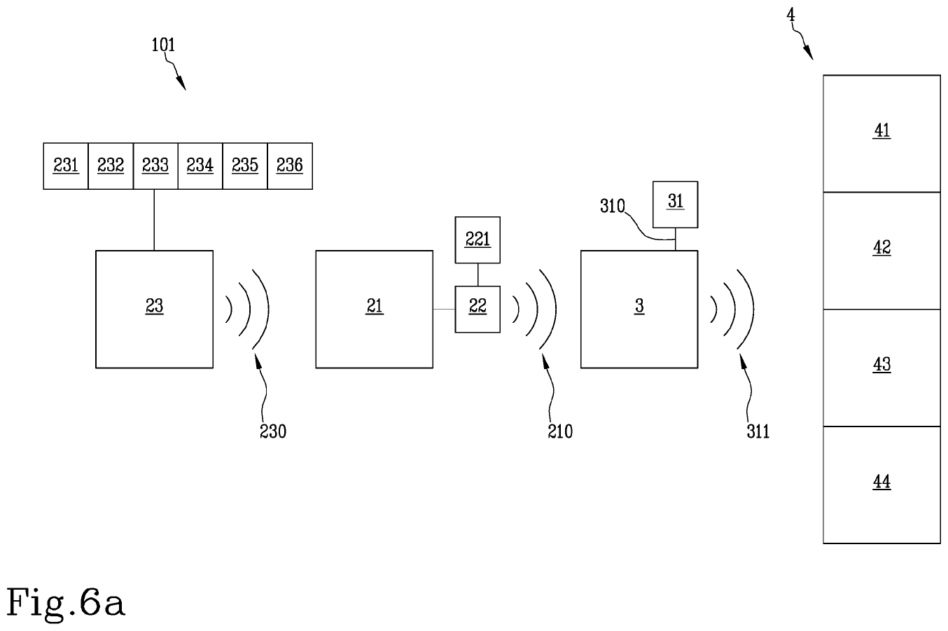

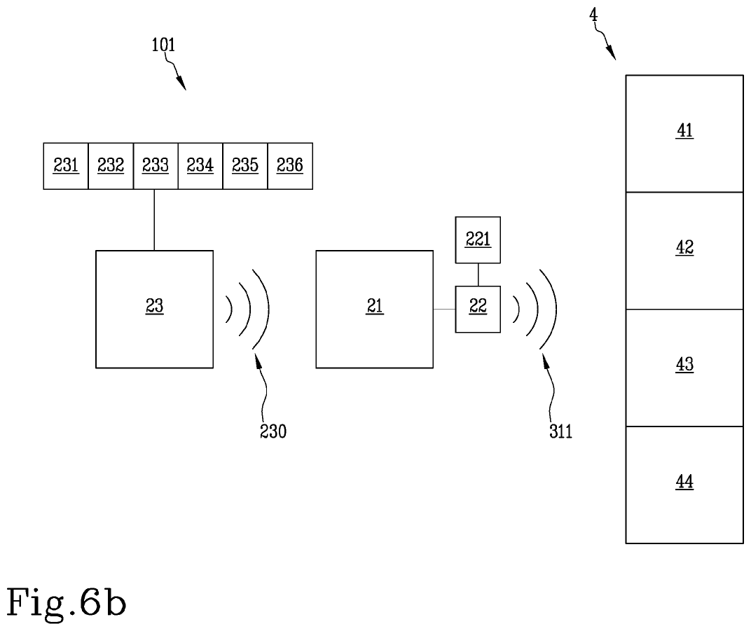

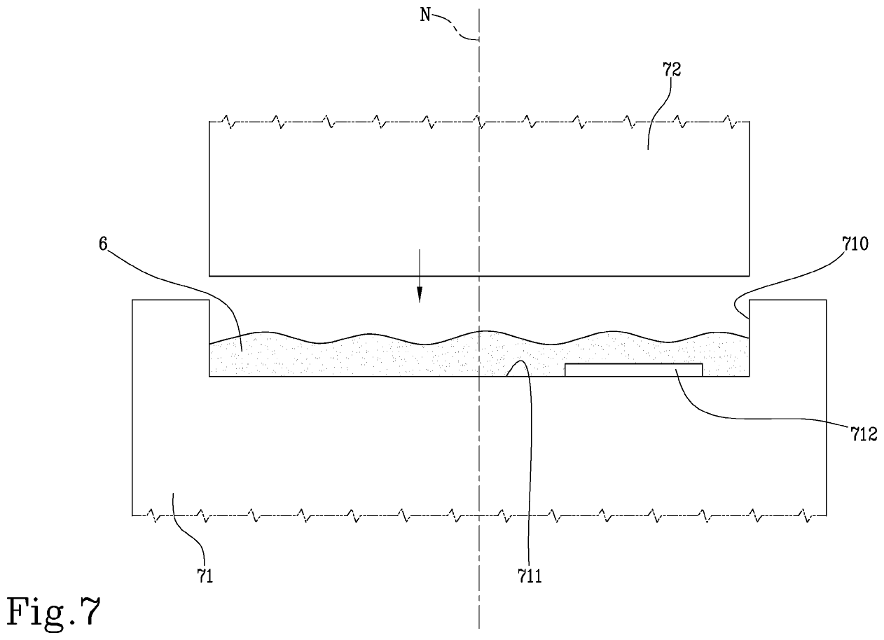

### DETAILED DESCRIPTION OF PREFERRED EMBODIMENTS OF THE INVENTION

The numeral 100 in the drawings denotes a tile. The tile 100 comprises a ceramic body 1. The ceramic body 1 includes a top surface 11, defining a visible surface of the tile 100, and an underside surface 12, defining a laying surface of the tile 100, configured to be fixed to a supporting surface when the tile is installed. The top surface 11 and the underside surface 12 are spaced from each other along an axis N normal to the top surface 11 and to the underside surface 12 of the ceramic body 1. The ceramic body 1 includes a perimeter edge 13. Preferably, the perimeter edge 13 of the body 1 forms a rectangular or square shape around the normal axis N.

The tile 100 comprises a recess 5 made in the underside surface 12 of the ceramic body 1. The recess 5 includes a perimeter edge 51. The perimeter edge 51 of the recess 5 forms a rectangular shape around an axis parallel to the normal axis N.

The ceramic body 1 is an axisymmetric body, defining at least one axis of symmetry S. In particular, the perimeter edge 51 of the recess 5 is spaced from the axis of symmetry S in a plane parallel to the top surface 11 (and to the underside surface 12). In particular, a distance 14 between the perimeter edge 13 of the ceramic body 1 and the perimeter edge 51 of the recess is between 4 mm and 6 mm, preferably greater than 5 mm. The perimeter edge 51 includes rounded corners 52.

The recess 5 comprises a bottom surface 53 and the ceramic body 1 comprises a first portion 15a having a first thickness 16a between the top surface 11 and the underside surface 12. The ceramic body 1 comprises a second portion 15b having a second thickness 16b between the top surface 11 and the bottom surface 53 of the recess 5. The second thickness 16b is between 3 mm and 8 mm and the first thickness 16 a is between 8 mm and 20 mm.

The ceramic body 1 is made from a mixture 6 comprising a toughening agent, having a concentration of between 0.28 % and 0.32 %. The ceramic body 1 is made in a mould 7. In an operating sequence for making the ceramic body 1, the mixture 6 is fed into a cavity 710 of a first element 71 of the mould 7. Next, a second element 72 of the mould 7 and the first element 71 move towards each other along the normal axis N to compress the mixture 6b and to form the ceramic body 1 of the tile 100. The first element 71 comprises a contact surface 711 which, during the compression of the mixture 6 to form the ceramic body 1, is in contact with the underside surface 12 of the ceramic body 1. Moreover, during compression, the first element 71 of the mould 7 comprises a protrusion 712 extending along an axis parallel to the normal axis N, perpendicular to the contact surface 711 so as to form the recess 5 in the underside surface 12 of the ceramic body 1.

The tile 100 comprises an electronic card 2. The electronic card 2 is positioned in the recess 5. In particular, the perimeter 51 of the recess 5 is shaped to accommodate the electronic card 2. Preferably, the electronic card 2 comprises a perimeter edge and the perimeter edge 51 of the recess 5 coincides with the perimeter edge of the electronic card 2. The tile 100 comprises a control unit 21, preferably a microcontroller, which is mounted on the electronic card 2. The tile 100 comprises a communication unit 22, mounted on the electronic card 2. The communication unit 22 comprises a transmitting device 221 (for example, a transceiver device). The tile 100 comprises a sensing unit 23 configured to capture at least one sensor signal 230 representing a value of a physical parameter detected in a boundary zone of the tile. The sensing unit 23 is located on the electronic card 2. The tile 100 comprises a memory 24 located on the electronic card 2.

In particular, the control unit 21 is connected to the sensing unit 23, to the communication unit 22 and to the memory 24.

The tile 1 also comprises a power supply system 25, located in the electronic card 2. The power supply system 25 comprises a plurality of batteries 251 located in a respective plurality of battery holders 252. The batteries 251 are preferably primary, lithium button batteries. The plurality of batteries 251 is located in a battery compartment 253 in the electronic card 2. The battery compartment 253 can be covered by a removable magnetic lid 254 which can be coupled to a magnetic frame 255 on the electronic card 2. The electronic card 2 comprises a battery management system 256 to manage the charge of the batteries 251, and a voltage regulator 257 to regulate the input voltage of the batteries 251 or the output voltage of the batteries 251. The sensing unit 23 comprises one or more sensors. The tile 100 is therefore a sensorized tile. The sensors of the sensing unit 23 are low energy consumption, MEMS sensors. Moreover, the sensors are configured to capture signals indicating when a predetermined threshold is exceeded or an event occurs; the sensors are therefore constantly active and connected to the power supply system 25 to receive a constant charge.

The control unit 21, the communication unit 22, the sensing unit 23 and the memory 24 are fixed to the recess 5 by a resin material. In particular, the electronic card 2 is fixed to the recess by the resin material and in contact with the control unit 21, the communication unit 22, the sensing unit 23 and the memory 24. In particular, the resin is poured until flush with the underside surface 12 of the ceramic body 1, while the power supply system 25 is covered by the removable lid 254.

The control unit 21 receives a sensor signal 230 from the sensing unit 23 and from it derives a corresponding value representing a physical parameter of the boundary zone of the tile 100. In an example, the tile 100 is located in a system 101 comprising a remote terminal 3 outside the tile 100. The control unit 21 is connected to the remote terminal 3. The control unit 21 processes a communication signal 210 comprising the sensor signal 230 and sends the communication signal 210 to the remote terminal 3 through the communication unit 22. The remote terminal 3 receives the communication signal 210 and processes the communication signal 210 to derive information 310 regarding the boundary zone of the tile 100. Alternatively, the control unit 21 processes the communication signal 210 to derive information regarding the boundary zone of the tile 100. In an example, the remote terminal 3 comprises a screen 31 to display the information 310 derived.

The sensing unit 23 comprises an oscillation sensor 237, configured to capture an oscillation signal, representing a value of vibration to which the ceramic body 1 is subjected; in particular, the remote terminal 3 is configured to process the communication signal comprising the oscillation signal by applying a Fourier transform algorithm to the oscillation signal.

The sensing unit 23 comprises a temperature sensor 231, a humidity sensor 232 and an accelerometer 233. The sensing unit 23 comprises an inclination sensor 235 for capturing an inclination signal representing a value of the inclination of the ceramic body 1 relative to a plane perpendicular to the direction of the weight force, a deformation sensor configured for capturing a deformation signal representing a value of deformation of the ceramic body 1.

The sensing unit 23 comprises a pressure sensor 234, configured to capture a pressure signal representing a value of pressure applied to the top surface of the ceramic body 1. The sensors monitor the state of the structure or the conditions of use of the structure in which the tile 100 is installed, for example ventilated façades or floating floors.

The system 101 comprises a plurality of actuators 4 and the remote terminal 3 processes a drive signal based on the communication signal or on the information derived therefrom. In particular, the control unit 21 compares the pressure value derived from the pressure signal with a predetermined pressure value, and the control unit 21 or the remote terminal 3 generates the drive signal 311 when the pressure value measured exceeds a threshold value or exceeds a predetermined length of pressure time or depending on the number of pressure values measured in a certain time interval. For example, the tile 100 may be located in a floor and when a person whose weight exceeds the predetermined value walks on the floor, the remote terminal 3 processes the drive signal 311 and sends it to an alerting system 41 of the group of actuators 4 and the alerting system 41 issues an alert, for example an acoustic alert, to notify of the presence of the person. For example, the tile 1 may be located in a floor or wall of a home and when a user touches the top surface of the tile, the remote terminal 3 processes the drive signal 311 and sends it to a sound system 42 which issues a music signal, or to a lighting system 43, which switches on or off, or to a camera system 44, which switches on or off. The tile 100 may be located in a pedestrian transit area (for example, a station or a shop) and when a person walks on it, the remote terminal 3 derives a length of standing time or a number of passes in order to process statistical information regarding the use of the transit area.

The following paragraphs, listed in alphanumeric order for reference, are non-limiting example modes of describing this invention.
A. A tile (100) comprising:
   a ceramic body (1), including a top surface (11) and an underside surface (12), opposite the top surface (11);
   a control unit (21), positioned on the underside surface (12) and programmed to generate a communication signal (210), and
   a communication unit (22), connected to the control unit (21) to receive the communication signal (210),
wherein the communication unit (22) is configured to send the communication signal (210) to a remote terminal (3).
   A.1. The tile (100) according to paragraph A, comprising a sensing unit (23) configured to capture at least one sensor signal (230), representing a value of a physical parameter detected in the boundary zone of the tile (100) and wherein the control unit (21) is connected to the sensing unit (23) to receive the at least one sensor signal (230).
      A.1.1. The tile (100) according to paragraph A.1, wherein the sensing unit (23) comprises one or more of the following sensors:
         a temperature sensor (231), configured to capture a temperature signal, representing a value of temperature in the boundary zone of the tile (100);
         a humidity sensor (232), configured to capture a humidity signal, representing a value of humidity in the boundary zone of the tile (100);
         an inclination sensor (235), configured to capture an inclination signal, representing a value of the inclination of the ceramic body relative to a plane perpendicular to the direction of the weight force;
         a pressure sensor (234), configured to capture a pressure signal, representing a value of pressure applied to the top surface of the ceramic body (100);
         an oscillation sensor (233), configured to capture an oscillation signal, representing a value of vibration to which the ceramic body (1) is subjected;
         a deformation sensor (236), configured to capture a deformation signal, representing a value of deformation of the ceramic body (1).
      A.1.2. The tile (100) according to paragraph A.1. or A.1.1., wherein the control unit (21) is configured to generate the communication signal (210) on the basis of the at least one sensor signal (230) and wherein the communication unit (22) comprises a transmitting device (221), configured to transmit the communication signal (210), representing the value of the physical parameter detected in the boundary zone of the tile (100).
   A.2. The tile (100) according to any one of the preceding paragraphs, comprising a recess (5), formed in the underside surface (12) of the ceramic body (1) and having a perimeter edge (51), wherein the control unit (21) and the communication unit (22) are positioned at least partly in the recess (5).
      A.2.1. The tile (100) according to paragraph A.2., wherein the ceramic body (1) is an axisymmetric body, defining at least one axis of symmetry(S) and wherein the perimeter edge (51) of the recess (5) is spaced from the axis of symmetry(S) in a plane parallel to the top surface (11).
      A.2.2. The tile (100) according to paragraph A.2. or A.2.1., wherein the ceramic body (1) comprises a respective perimeter edge (13) and wherein a distance (14) between the perimeter edge (51) of the recess (5) and the perimeter edge (13) of the ceramic body (1) is greater than 4 cm.
      A.2.3. The tile (100) according to any of the paragraphs from A.2. to A.2.2., wherein the perimeter edge (51) of the recess (5) includes rounded corners (52).
      A.2.4. The tile (100) according to any of the paragraphs from A.2. to A.2.3., wherein the recess (5) comprises a bottom surface (53) and wherein the ceramic body (1) comprises a first portion (15a), having a first thickness (16a) between the top surface (11) and the underside surface (12), and a second portion (15b), having a second thickness (16b) between the top surface (11) and the bottom surface (53) of the recess (5), the second thickness being between 3 mm and 8 mm.
      A.2.5. The tile (100) according to any of the paragraphs from A.2. to A.2.4., wherein the control unit (21) and the communication unit (22) are fixed to the recess (5) by a resin material.
   A.3. The tile (100) according to any one of the preceding paragraphs, wherein the ceramic body (1) is made from a mixture (6) comprising a toughening agent, having a concentration of between 0.35 % and 0.45 %.
B. A system (101) comprising
   a tile (100) according to any of the paragraphs from A. to A.3. ;
   a remote terminal (3), connected to the control unit (21) of the tile (100) and configured for:
      receiving the communication signal (210),
      processing the communication signal (210),
      deriving information (310) about the boundary zone of the tile (100), based on the communication signal (210).
   B.1. The system (101) according to paragraph B., comprising one or more actuators (4) and wherein the remote terminal (3) is configured to send drive signals (311) to the one or more actuators (4), based on the communication signal (210) received from the control unit (21), or
      wherein the control unit (21) is configured to send drive signals (311) to the one or more actuators (4), based on the sensor signal (230) received from the sensing unit (23).
C. A method for exchanging signals with a tile (100), wherein the tile (100) comprises:
   a ceramic body (1), including a top surface (11) and an underside surface (12), opposite the top surface (11);
   a control unit (21), positioned on the underside surface (12);
   a communication unit (22), connected to the control unit (21);
      the method comprising the following steps:
generating a communication signal (210) through the control unit (21);
sending the communication signal (210) to a remote terminal (3) through the communication unit (22).
   C.1. The method according to paragraph C, wherein the tile (100) comprises a sensing unit (23) connected to the control unit (21), the method comprising the following steps:
      via the sensing unit (23), capturing a sensor signal (230) representing a value of a physical parameter detected in a boundary zone of the tile (100);
      receiving the at least one sensor signal (230) at the control unit (21), wherein the step of generating the communication signal (210) is performed on the basis of the sensor signal (230) received.
D. A method for manufacturing a tile (100), wherein the tile (100) comprises:
   a ceramic body (1), including a top surface (11) and an underside surface (12), opposite the top surface (11) and a recess (5) formed on the underside surface (12),
      the method comprising the following steps:
feeding a cavity (710) of a first element (71) with a ceramic mixture (6),
compressing the ceramic mixture (6) by moving the first element (71) and a second element (72) towards each other to form the ceramic body (1) of the tile (100),
wherein the first element (71) comprises a contact surface (711) which, in the step of compressing, is in contact with the underside surface (12) of the tile (100) and wherein the first element (71) comprises a protrusion (712) extending towards an axis (N) normal to the contact surface (711) to make the recess (5) in the underside surface (12) of the ceramic body (1).
   D.1. The method according to paragraph D., comprising the following steps:
providing a control unit (21) and a communication unit (22), connected to the control unit (21);
assembling the control unit (21) and the communication unit (22) to the ceramic body (1), wherein the control unit (21) and the communication unit (22) are positioned at least partly in the recess (5).

1. A system comprising a sensorized tile, wherein the sensorized tile includes:
a ceramic body, including a top surface and an underside surface opposite the top surface;
a control unit, positioned on the underside surface and programmed to generate a communication signal;
a communication unit, connected to the control unit to receive the communication signal, and
a sensing unit configured to capture at least one sensor signal representing a value of a physical parameter detected in a boundary zone of the tile,
wherein the control unit is connected to the sensing unit to receive the at least one sensor signal and is configured to generate the communication signal in response to the sensor signal.

2. The system according to claim 1, wherein the sensing unit comprises one or more of the following sensors:
a temperature sensor, configured to capture a temperature signal, representing a value of temperature in the boundary zone of the tile;
a humidity sensor, configured to capture a humidity signal, representing a value of humidity in the boundary zone of the tile;
an inclination sensor, configured to capture an inclination signal, representing a value of the inclination of the ceramic body relative to a plane perpendicular to the direction of the weight force;
a pressure sensor, configured to capture a pressure signal, representing a value of pressure applied to the top surface of the ceramic body;
an oscillation sensor configured to capture an oscillation signal, representing a value of vibration to which the ceramic body is subjected;
a deformation sensor, configured to capture a deformation signal, representing a value of

3. The system according to claim 1, comprising one or more actuators from those listed below:
an alerting system, configured to issue an alert signal;
a sound system, configured to issue a music signal;
a lighting system configured to switch on or switch off;
a camera system configured to switch on or switch off.

4. The system according to claim 3, wherein the detection unit comprises the pressure sensor, the control unit being programmed for:
deriving the pressure value,
comparing the pressure value with a predetermined pressure value and
generating a drive signal for the pressure value that is greater than the predetermined pressure value.

5. The system according to claim 4, comprising the alerting system, wherein the control unit is configured to send the drive signal to the alerting system to instruct it to issue an alert signal.

6. The system according to claim 4, comprising the sound system, wherein the control unit is configured to send the drive signal to the sound system to instruct it to issue a music signal.

7. The system according to claim 4, comprising the lighting system and the camera system, wherein the control unit is configured to send the drive signal to the lighting system and to the camera system to instruct them to switch on or switch off.

8. The system according to claim 1, wherein the tile comprises a wireless charging system, configured to transmit electrical energy in wireless mode to an external power supply to charge it.

9. The system according to claim 1, comprising a remote terminal, connected to the control unit of the tile to receive the communication signal from the communication unit, wherein the communication signal represents a pressure value over time, applied to the ceramic body of the tile, the remote terminal being programmed to derive a number of persons walking over the tile and/or a length of time each person stands on the tile.

10. A method for using a sensorized tile, wherein the sensorized tile includes:
a ceramic body, including a top surface and an underside surface, opposite the top surface;
a control unit, positioned on the underside surface;
a communication unit, connected to the control unit; and
a sensing unit, connected to the control unit,
the method comprising the following steps:
via the control unit, generating a communication signal and transmitting the communication signal to the communication unit;
via the sensing unit capturing at least one sensor signal representing a value of a physical parameter detected in a boundary zone of the tile, and transmitting the sensor signal to the control unit,
via the control unit, receiving the at least one sensor signal and generating the communication signal in response to the sensor signal.

11. The method according to claim 10, wherein the sensing unit comprises one or more of the following sensors:
a temperature sensor, configured to capture a temperature signal, representing a value of temperature in the boundary zone of the tile;
a humidity sensor, configured to capture a humidity signal, representing a value of humidity in the boundary zone of the tile;
an inclination sensor, configured to capture an inclination signal, representing a value of the inclination of the ceramic body relative to a plane perpendicular to the direction of the weight force;
a pressure sensor, configured to capture a pressure signal, representing a value of pressure applied to the top surface of the ceramic body;
an oscillation sensor, configured to capture an oscillation signal, representing a value of vibration to which the ceramic body is subjected;
a deformation sensor, configured to capture a deformation signal, representing a value of deformation of the ceramic body.

12. The method according to claim 11, wherein the sensing unit comprises the pressure sensor, the method comprising the following steps, performed by the control unit:
deriving a pressure value,
comparing the pressure value with a predetermined pressure value;
generating a drive signal for the pressure value that is greater than the predetermined pressure value.

13. The method according to claim 12, comprising a step of transmitting the drive signal, via the control unit, to at least one of the following:
an alerting system to instruct it to issue an alert signal;
a sound system to instruct it to issue a music signal;
a lighting system to instruct it to switch on or switch off;
a camera system to instruct it to switch on or switch off.

14. The method according to claim 10, wherein the tile comprises a wireless charging system, and the method comprises a step of transmitting electrical energy in wireless mode to an external power supply to charge it.

15. The method according to claim 10, comprising the following steps:
via the control unit, sending the communication signal to a remote terminal, the communication signal representing a pressure value over time, applied to the ceramic body of the tile;
via the remote terminal, deriving a number of persons walking over the tile and/or a length of time each person stands on the tile.
